(19) United States
(12) Patent Application Publication
(10) Pub. No.: US 2012/0036081 A1
(43) Pub. Date: Feb. 9, 2012

(54) METHOD AND SYSTEM FOR A REAL-TIME INTERACTIVE WEB/MEDIA-BASED ELECTRONIC NEW OR REMOTE HIRE DOCUMENT PROCESSING SYSTEM INTERFACED/INTERLINK TO AN EMPLOYER AUTHORIZED DISTAL/REMOTE NOTARIES PUBLIC OR 3RD PARTY AGENT

(76) Inventors: Brenda F. HATTER, CORONA, CA (US); Jesse A. HATTER, II, CORONA, CA (US); Sariyah Y. HATTER, CORONA, CA (US); Miykael S. HATTER, CORONA, CA (US); Rosie J. HATTER, COMPTON, CA (US); Michael D. HATTER, COMPTON, CA (US); Robert L. JACKSON, LOS ANGELES, CA (US); Audrella JACKSON, LOS ANGELES, CA (US); Gene WILEY, PERRIS, CA (US); Linton WILEY, PERRIS, CA (US); Anthony L. JACKSON, CORONA, CA (US); Gregory JONES, LOS ANGELES, CA (US); Curtis A. PATTON, MONTEREY PARK, CA (US); Edward Ederaine, CORONA, CA (US); Derwin K. Stewart, COMPTON, CA (US); Reginald Ferrell, ONTARIO, CA (US)

(21) Appl. No.: 13/271,605

(22) Filed: Oct. 12, 2011

Related U.S. Application Data
(63) Continuation-in-part of application No. 12/554,735, filed on Sep. 4, 2009.
Application No. 12/554,735 is a continuation-in-part of application No. 11/880,618, filed on Jul. 23, 2007, now Pat. No. 7,590,852.
(60) Provisional application No. 61/404,884, filed on Oct. 12, 2010.

(51) Int. Cl. G06Q 10/06

(52) U.S. Cl. 705/321

(57) ABSTRACT

Disclosed is an interactive web based method and system facilitating an employee to virtually and electronically process their employee eligibility verification and certification with a live remote Notary Public or authorized third party agent; comprising on demand functionality implementing web-based appointment booking, on-line payment platform, secure web based interactive videoconferencing communication 42 in real-time, digital webcam, real-time identification authenticating, digital video secure socket layer signing certificate, secure digital and annotating signing, network document delivery system, and secure archive.

Method and system for a real-time interactive web/media based electronic new or remote hire document processing system interfaced/interlinked to an employer authorized distant/remote notaries public or 3^{rd} party agent.

### CROSS REFERENCE TO RELATED APPLICATION

This application claims the benefit of Provisional Application Ser. No. 61/404,884 filed Oct. 12, 2010 and is a Continuation in Part of application Ser. No. 12/554,735 filed on Sep. 4, 2009 and is a Continuation in Part of application Ser. No. 11/880,618 filed on Jul. 23, 2007, that issued on Sep. 15, 2009 as U.S. Pat. No. 7,590,852 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a virtual notary, more particularly, performing live electronic personal signatory verification, authentication and screening for the purpose of transacting remote electronic notarizations with live notaries. For verification and checking of employer for I-9.

2. Description of Related Art Including Information Disclosed under 37 CFR 1.97 and 1.98

Companies have spent billions of dollars on developing technology for devices which facilitate real-time video communication between parties to engage in a variety of activities ranging from recreational to major business activity.

The innovation for real-time remote hire eligibility, verification and certification electronic document processing via secure videoconference with a live Notary Public or authorized third party agent is just one example of the many innovations which will emerge in this new era of communications technology.

In 1986 the Immigration Reform and Control Act (IRCA) required employers to examine documentation from each newly hired employee to prove his or her identity to work in the United States.

This act gave birth to the Form I-9 Employee Eligibility Verification and Certification which when endorsed and attested to by the employee, employer, or authorized designated agent of the employer. Form I-9 attestation by both the employee and employer provides the basis for prosecution in the event perjury is committed from identity fraud or false information is presented.

In 1997, the basic pilot program hosted by the INS in conjunction with the Social Security Administration (SSA) was launched in California, Florida, Illinois, Nebraska, New York and Texas.

The Basic Pilot Program used information from the employee's Form I-9 and compared it to the information in INS and SSA records. To verify information with SSA, employers were required to call SSA. Once the SSA information was confirmed by phone, the employer entered I-9 data into a computer program which transmitted the data to INS via a modem connection. In 1999, the INS in conjunction with the Social Security Administration (SSA) implemented the Designated Agent Basic Pilot Program. The Designated Agent Basic Pilot Program was voluntary and allowed employers to use a third-party agent to confirm the work eligibility of their newly hired employees.

In 2004 the basic pilot program began a new program to integrate a web based access method to confirm employment eligibility.

By 2007 the basic pilot program was renamed to be what is now known as “E-Verify”. The E-Verify program added more features including an automatic flagging system that prompts employers to double-check the data entered into the web interface for those cases that are about to result in a mismatch. This change reduced data entry errors and initial mismatches by approximately 30 percent.

June 12, 2011, the United States Citizenship and Immigration Services (USCIS) will release its latest version of the E-Verify web user interface, which is designed to add more functionality particularly to thwart document fraud through driver's license data verification.

The U.S. Government, Department of Homeland Security (DHS), U.S. Custom Immigration Services (USCIS), and Immigration Custom Enforcement (ICE) rules for Form I-9 completion mandate a 72 hour period from the employees first day of work for pay.

This presents a major challenge. Non-compliance with this mandate can be expensive in fines and ruin the reputation of the employer in penalties.

The Form I-9 has been a challenge for those conducting manual processing. Often areas of this document are incorrectly populated with the wrong information or information is simply omitted. An employer is liable for any violations in connection with the form or the verification process regardless of who fills out or enters data on the form.

In the U.S. many state legislatures have mandated the usage of E-Verify. Each E-Verify query requires a correctly completed Form I-9. Presently form I-9 document does not require notarization. The recommendation of U.S.C.I.S. is for using notaries to assist in the employee eligibility verification and certification process is based on two key elements. A Notary Public is a duly sworn officer of the State wherein he or she is commissioned and under the jurisdiction of the Secretary of State.

A Notary Public is sensitive to the appropriate handling, completion, and signing of important documents. For employers and new remote hire employees it can be difficult finding a Notary Public willing and trained to assist in the execution of the employee eligibility, verification and certification as required in the completing of Form I-9.

Recently U.S. Federal legislators have introduced a bill that would repeal all paper based Form I-9 processing, which will require all Form I-9 to be processed electronically. This innovation provides a unique method and system compliant with U.S.C.I.S. requirements for the electronic processing of the employee eligibility verification and certification Form I-9.

Some patents have been issued on remote signing and party validation. Examples of these patents are disclosed herein. U.S. Pat. No. 6,904,416 issued on Jun. 7, 2005 and U.S. published application 2002/0143711 to Nicholas N. Nassiri discloses a signature verification using a third party authenticator via a paperless electronic document platform. While this patent discloses an authorization system, it does not provide for a secure visual verification using data from various authorities and databases.

U.S. Pat. No. 7,096,005 issued on Aug. 22, 2006 to Lai et al. discloses a method of carrying out a safe remote electronic signing by cellular phone. While this patent provides for an e-signature it does not provide for the other requirements for a notary authorization.

U.S. Pat. No. 7,130,452 issued on Oct. 31, 2006 to Bolle et al. discloses a system and method for multi-party validation, authorization and/or authorization via biometrics. The biometrics includes signature, thumb print, voice print and retinal scan. The biometrics allows for authorization from a person they exist at a doorway or other portal to grant access. There are also no provisions for using data from various authorities and databases.

Although prior arts, U.S. Pat. No. 6,904,416 and U.S. Pat. No. 7,096,005 contain varying approaches to both electronic signing and signature verification, neither allow for the remote usage of the electronic journal and nor do they address a method of compensation for the notary and ultimately these arts neglect to offer a potential signatory the opportunity to receive notary services remotely through electronic devices as well as receive notary services utilizing remote electronic identity authorization devices on-line.

What is needed is an electronic system that allows and employer or employee to correctly complete the Form I-9 where the electronic system pulls verification from a number of authorities to verify that the employee is eligible to work.

### BRIEF SUMMARY OF THE INVENTION

It is an object of the real-time employee verification to be a web based solution to allow new and or remote hire employees to engage with live Notaries Public on-line in real-time via a videoconferencing communication which is recorded and archived; to electronically execute employee eligibility certification and verification completing Form I-9 electronically.

It is another object of the real-time employee verification to verify employee remote hire eligibility, verification and certification electronic document processing via secure videoconference with a live Notary Public or authorized third party agent is based on a few different factors.

It is another object of the real-time employee verification to satisfy 3 main standards that must be adhered to in order for the Department of Homeland Security (DHS) determining the proper completion of an electronic Form I-9 or designated employee eligibility verification and certification form, according to the U.S.C.I.S. Handbook for Employers M-274 revised 6/2011 is sited as stating,

If you complete Forms I-9 electronically using an electronic signature, your system for capturing electronic signatures must allow signatories to acknowledge that they read the attestation and attach the electronic signature to an electronically completed Form I-9.

It is another object of the real-time employee verification for the system (1.) Affix the electronic signature at the time of the transaction; (2.) Create and preserves a record verifying the identity of the person producing the signature; and (3.) Upon request of the employee, provide a printed confirmation of the transaction to the person providing the signature.

It is still another object of the real-time employee verification for the system to capture the electronic signature and a method to acknowledge that the attestation to be signed has been read by the signatory.

The innovation disclosed herein incorporates the spirit of all three standards.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a diagram of the cloud computing platform.

FIG. 2 shows a diagram of the electronic document production.

FIG. 3 shows a diagram of the stenography electronic font line embedding and deciphering.

FIG. 4 shows a diagram of the payment transaction flow chart.

FIG. 5 shows a diagram of document storage and retrieval.

### DETAILED DESCRIPTION OF THE INVENTION

It is important that an understanding of the laws and regulations both current and future, amendments, and their subsequent allowances and disallowances that the spirit, scope, and inchoative nature of this invention is based. Any changes, alterations, or modification in this art are considered to be seen and included within this present invention however regulated on all levels of adjudication and legal precedence.

The web based network for electronically processing employee eligibility certification and verification completing Form I-9 architecture is designed to operate utilizing cloud computing platform (or the similar) which allows flexibility in data protection, network interfacing, redundancy, and storage capabilities. Scalable bit encryption as required.

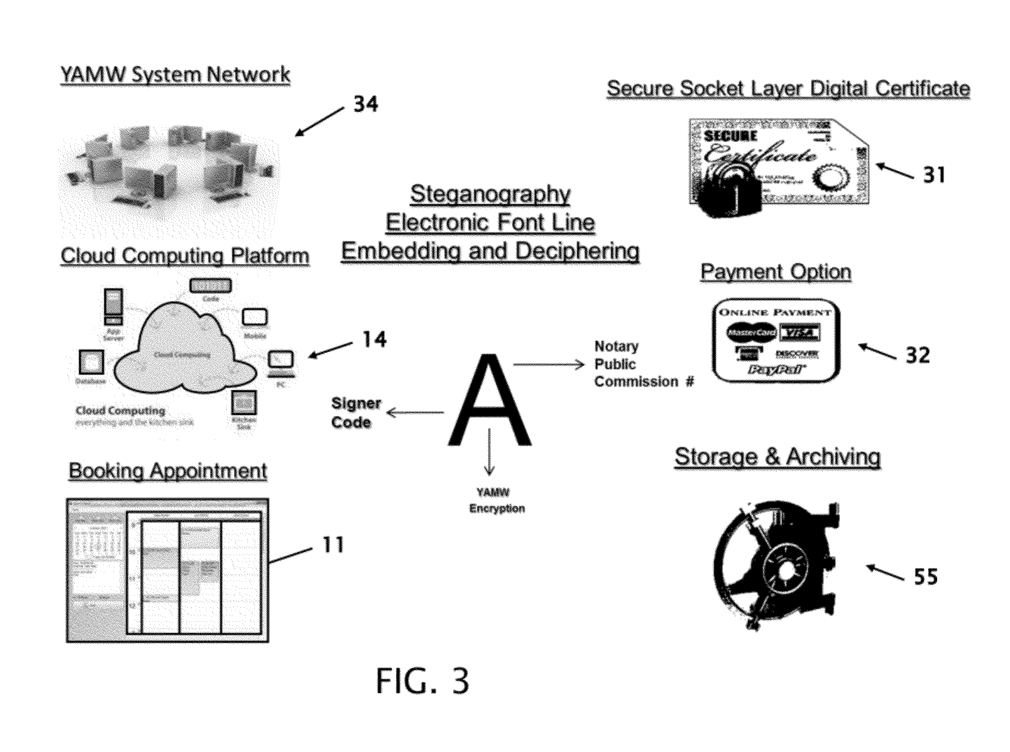

The YAMW system network components are compliant with Statement on Auditing Standards (SAS)-70, Health Insurance Portability and Accountability Act (HIPPA), and Web-Trust standards. Secure Socket Layer (SSL) digital certificate 30 (FIG. 3) multi-bit encryption credentialing includes a process for creating a video stream to be embedded into the credential appeasing Federal Bridge Certification Authority (FBCA) requirements for an antecedent in-person identity proofing event. An employee is to present a Federal Government-issued picture/photo/other I.D., or two Non-Federal Government I.D.'s, one of which shall be a photo I.D. e.g., driver's license. Notary Public or third party agent is pre-authorized by an employer as their designated agent to certify and verify their employee's identification documents.

In addition the Notary Public or third party agent may digitally sign the Form I-9 on behalf of the employer and obtain the employee's digital signature for the Form I-9. Notary Public certifying the employee's identification documents and digital signature or auditable confirmation of identity proofing process is recorded.

The electronic employee eligibility certification and verification Form I-9 completion process begins by an employee with a digital web camera (or other video technology device) attached to or apart of their Television, Gaming Device, interactive videoconferencing communication platform, video time-watch, Personal Computer, portable Personal Computer, PDA, cellular smart phone device, or any other fixed or portable computer communication device, hereinafter known as “devices” capable of real-time videoconferencing interactive communication and internet connectivity, accesses the YAMW system network website.

Booking Appointment Processing

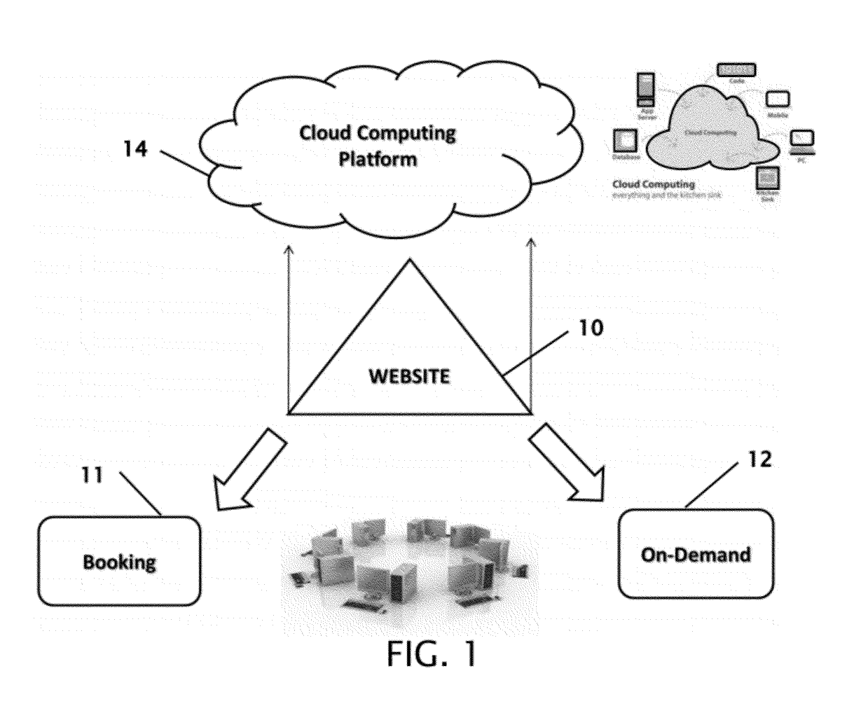

FIG. 1 shows a diagram of the cloud computing platform. The employee accessing the designated website 10 for processing their electronic Form I-9 or designated employee eligibility verification and certification form with a pre-registered on-line live Notary Public or pre-authorized third party agent via their devices and may either choose the ancillary option to “Book” 11 an appointment that includes time, date, email and other data employee demographic data fields. Employee may also select from a list of pre-registered on-line on-demand 12 live Notary Public or pre-authorized third party agent requesting future electronic Form I-9 or designated employee eligibility verification and certification form processing. Booking Appointment completion prompts a system generated fill-able template comprised of blank highlighted fields for basic employee demographic data entry for SSL digital multi-bit encryption credentialing interface 25 and digital signature creation 44. The transaction can all take place within the cloud computing platform of the Internet 14. The system can send a confirmation Email 60 to notify the parties of a future signing appointment.

Electronic Document Preparation and Submission

Booking appointment request is sent and retrieved via electronic delivery system (EDS) to the pre-registered on-line live Notary Public or pre-authorized third party agent. Electronic document preparation and submission is via (DS to employee/user 61.

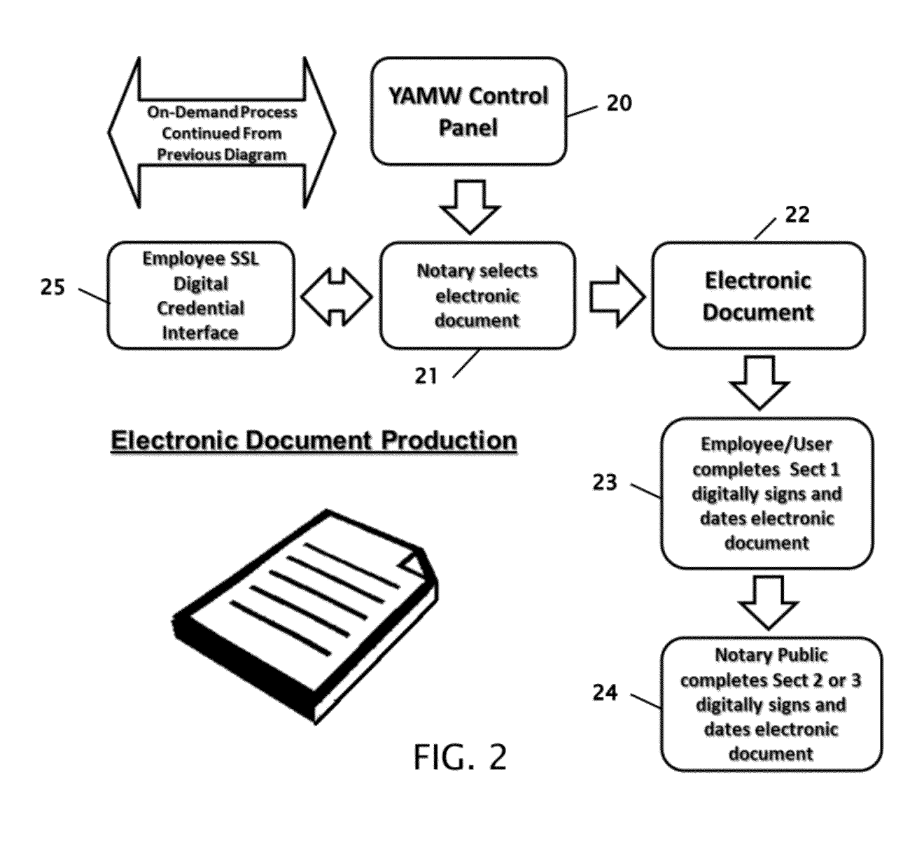

FIG. 2 shows a diagram of the electronic document production. On the appointment date and time of the employee/user, the pre-registered on-line live Notary Public or pre-authorized third party agent via website and pass word code accesses electronic document delivery template via application program interface to document signing solution, inputting employee user name and e-mail address to get to the YAMW Control panel 20.

The pre-registered on-line live Notary Public or pre-authorized third party agent also will input their name and e-mail address into electronic document delivery template and using drop down option select 21 the electronic Form I-9 document 22 or designated employee eligibility verification and certification form for signing by both pre-registered on-line live Notary Public or pre-authorized third party agent and employee/user.

Electronic Form I-9 or designated employee eligibility verification and certification form is 1^{st} submitted to and retrieved by employee/user via electronic delivery system (EDS).

Employee/user completes designated section 23 of Electronic Form I-9 or designated employee eligibility verification and certification form, digitally signs, dates and 2^{nd} submits via electronic delivery system (EDS) to Pre-registered on-line live Notary Public or pre-authorized third party agent.

Pre-registered on-line live Notary Public or pre-authorized third party agent retrieves digitally signed and dated 1st submitted electronic Form I-9 or designated employee eligibility verification and certification form and reviews document for error and omissions.

Real-Time Interactive Video Conferencing Connectivity

Pre-registered on-line live Notary Public or pre-authorized third party agent via website access video conference platform, selects invite module, entering employee/user email address into module, sending secure video conferencing link to employee/user Via electronic delivery system (EDS), employee/user retrieves video conferencing link to access video conferencing platform joining the Pre-registered on-line live Notary Public or pre-authorized third party agent. Pre-registered on-line live Notary Public or pre-authorized third party agent activates recording function of video conference.

Final Electronic Document Disposition

Pre-registered on-line live Notary Public or pre-authorized third party agent implements desktop share function displaying digitally signed and dated 1st submitted electronic Form I-9 or designated employee eligibility verification and certification form and completes pre-designated data fields, digitally signing and dating section 2 24 of the electronic Form I-9 or designated employee eligibility verification and certification form.

Pre-registered on-line live Notary Public or pre-authorized third party agent executes a 3^{rd} submission of document to digital signing solution affixes all inputted data by both signers and locks the electronic document generating an audit schedule sheet indicating time and date stamping, barcode, check sum code, IP address, and signing sequence.

Digital signing solution generates a 4^{th} submission and via electronic delivery system (EDS) produces link for the electronic Form I-9 or designated employee eligibility verification and certification form for locked PDF conversion download attached to an audit schedule sheet indicating time and date stamping, barcode, check sum code, IP address, and signing sequence sent to the employee/user, pre-registered on-line live Notary Public or pre-authorized third party and YAMW system network storage and archive module.

Pre-registered on-line live Notary Public or pre-authorized third party agent terminates desktop share function, recording, video conference meeting.

On-Demand Processing

The employee may choose the “On-demand” function; prompts a fill-able template comprised of blank highlighted fields for basic employee demographic data entry for SSL Digital multi-bit encryption credentialing interface 25 and digital signature creation 44.

Payment

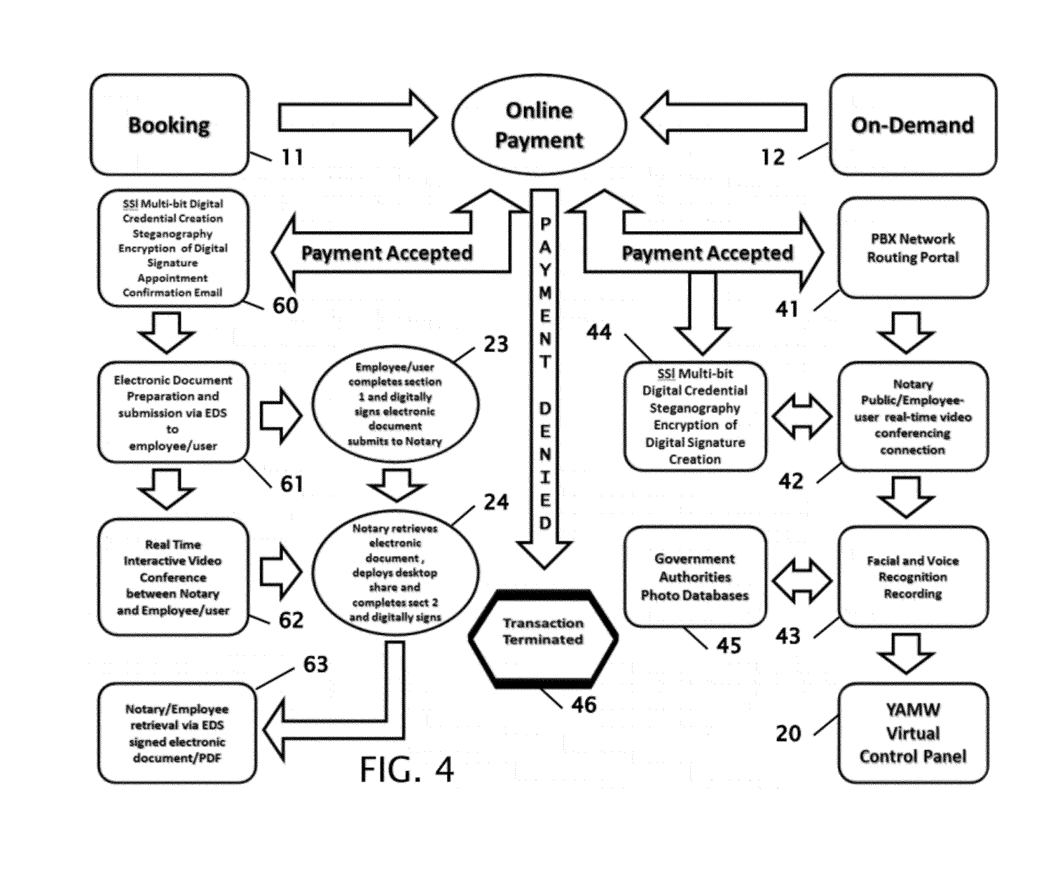

FIG. 4 shows a diagram of the payment transaction flow chart. Creation of SSL Digital multi-bit encryption credentialing interface 25 and digital signature or Booking an Appointment, prompts an online payment 40 option screen allowing credit card, debit card, pre-paid service codes, or check number data entry or other forms of payment. If payment information is denied for insufficient funds, YAMW system will delete SSL multi-bit encryption credential interface 25 and digital signature fill-able template information and transaction will terminate 46.

Notary Public/Employee-User Connectivity

Employee-user payment information approval prompts the YAMW system network to capture on-demand employee eligibility verification and certification request and forwards request via on-line PBX network routing portal 40 interfaced/interlinked to a YAMW system network pre-registered on-line live Notary Public or pre-authorized third party agent, establishing secured VPN videoconferencing communication 42 connectivity with the user/employee.

Pre-registered on-line live Notary Public or pre-authorized third party agent activates interactive videoconferencing recording function establishing an electronic video conference recording of the electronic Form I-9 or designated employee eligibility verification and certification form processing, and the real-time interactive communication between the employee/user and Pre-registered on-line live Notary Public or pre-authorized third party agent 62. Established real-time interactive secure videoconferencing communication 42 link, prompts YAMW system to deploy user/employer SSL digital multi-bit encryption credential interface 25 and steganography embedding process within the electronic font lines for both digital signatures of pre-registered on-line live Notary Public or pre-authorized third party agent and the employee/user comprised of algorithmically converted demographic information from the respective credentials registrations. FIG. 3 shows a diagram of the stenography electronic font line embedding and deciphering 31. The YAMW System Network 34, Cloud Computing Platform 14, appointment booking 11, secure socket layer digital certificate, payment option 32 and storage & archiving 55.

Digital credential completion cue's facial and voice recognition capturing 43 software and recording process that includes facial and voice recognition capturing software is interlinked to (but not limited to) government authorized employee eligibility network to compare photo capture with user/employee photo in government authorized employee eligibility network photo database 45 (or other verifiable options). Secondary photo matching optionally and systematically queries alternative photo matching databases for employee picture identification verification. User/employee facial recognition electronically record 43 is digitally attached to the user/employee eligibility certification and verification transaction.

YAMW System Network Control Panel

Secured real-time interactive videoconferencing communication 42 connectivity between pre-registered on-line live Notary Public or pre-authorized third party agent and user/employee 62 prompts YAMW system network display of virtual control panel consisting of electronic Form I-9 or designated employee eligibility verification and certification form, government authorized employee eligibility network access, Social Security Number Verification Service (SSNVS), digital signing controls and other functions.

Electronic Document Production and Disposition

Pre-registered on-line live Notary Public or pre-authorized third party agent selects electronic Form I-9 or designated employee eligibility verification and certification form from the YAMW system network control panel, prompting a fill-able Form I-9 or designated employee eligibility verification and certification form PDF. Electronic Form I-9 or designated employee eligibility verification and certification fill-able PDF contains pre-formatted data field and signature fields.

Electronic Form I-9 or designated employee eligibility verification and certification form is displayed in real-time within YAMW real-time interactive videoconferencing communication 42 platform with user/employee demographic information from user/employee SSL digital multi-bit encryption credential interface 25 pre-populating the electronic Form I-9 or designated employee eligibility verification and certification form with the user/employee's name and address.

Pre-registered on-line live Notary Public or pre-authorized third party agent via YAMW real-time interactive videoconferencing communication 42 platform witnesses the completion include date of birth, social security number (optional), citizenship status declaration, and drop down calendar populating the section 1 date field and selecting digital signing type to sign or annotating function for digital signature affixing to digital signature field of section 1 23 of the electronic Form I-9 or designated employee eligibility verification and certification form. Completion of the electronic Form I-9 or designated employee eligibility verification and certification form by the user/employee prompts system to lock section 1 23 of the document from the user/employee. Pre-registered on-line live Notary Public or pre-authorized third party agent, request display of user/employee identification for verification. YAMW system network may interface/interlink to issuing agency, for real-time verification of user/employee identification document.

Pre-registered on-line live Notary Public or pre-authorized third party agent enters the user/employers identification into pre-formatted data fields in section 2 24 of the electronic Form I-9 or designated employee eligibility verification and certification form.

Pre-registered on-line live Notary Public or pre-authorized third party agent request from the user/employee their start day of work for pay and inputs selects this date from a drop down calendar populating the certification user/employee start date field.

Pre-registered on-line live Notary Public or pre-authorized third party agent completes the user/ employee certification in section 2 24 of the electronic Form I-9 or designated employee eligibility verification and certification form inputting employee information into the data fields which include the user/employee employer address, selecting date from a drop down calendar populating the certification pre-registered on-line live Notary Public or pre-authorized third party agent date field.

Pre-registered on-line live Notary Public or pre-authorized third party agent selects digital signature field with type to sign feature or annotating function for digital signature affixing to digital signature field in section 2 24 of the electronic Form I-9 or designated employee eligibility verification and certification form. YAMW system validates all information inputted by both user/employee and pre-registered on-line live Notary Public or pre-authorized third party agent and affixes a time and date stamp to completed electronic Form I-9 or designated employee eligibility verification and certification form. The completed document is then placed in the notary/employee retrieval via EDS signed electronic document/PDF 63.

YAMW system produces an audit of the transaction indicating identities of all parties inputting data, sequence of signatures, and time date stamp logically attached to the electronic Form I-9 or designated employee eligibility verification and certification form.

YAMW system creates a PDF link for access and download of the electronic Form I-9 or designated employee eligibility verification and certification form via electronic delivery system (EDS) by employee/user.

YAMW system creates secondary PDF of the electronic Form I-9 or designated employee eligibility verification and certification form and videoconferencing recording link for download by the employer via electronic delivery system (EDS).

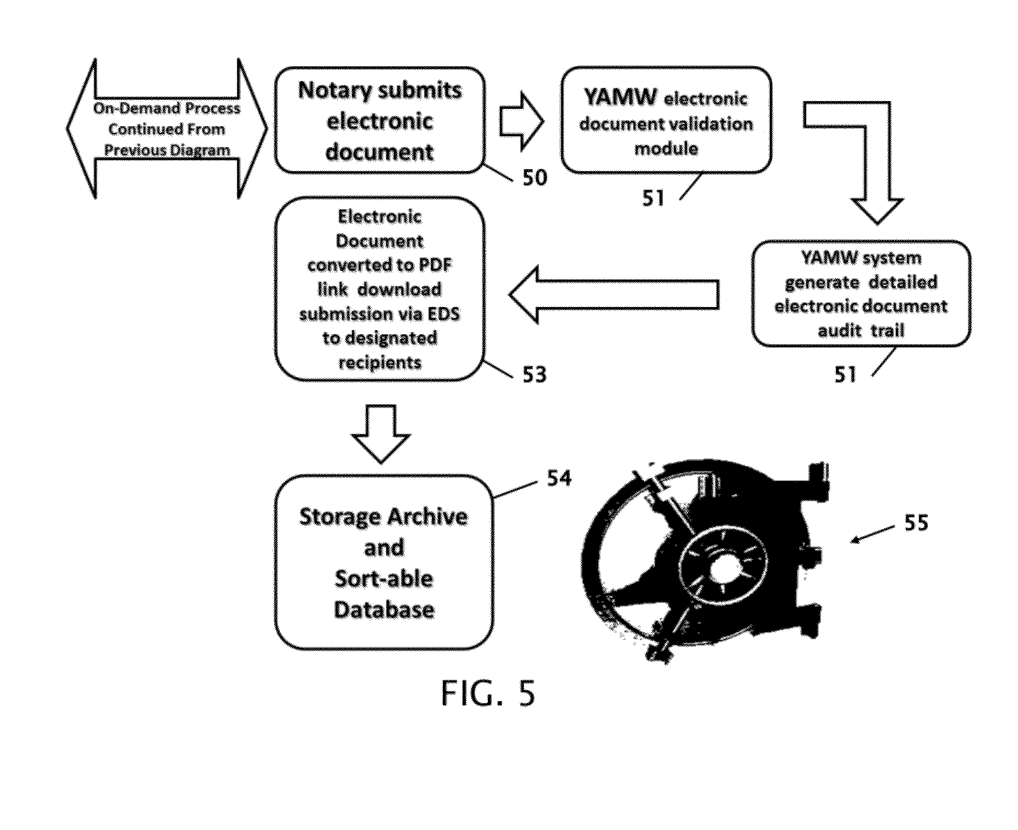

FIG. 5 shows a diagram of document storage and retrieval. YAMW system archives in storage via sort-able database, both completed electronic Form I-9 or designated employee eligibility verification and certification form and videoconferencing recording link for downloading electronic Form I-9 or designated employee eligibility verification and certification form transaction terminates 46.

Within the system, when a notary submits an electronic document 50 the YAMW validates the document in a document validation module 51 to ensure that the data has been correctly entered without anomalies. The YAMW system then generates a detailed electronic document audit trail 52. Electronic documents are converted to PDF links for download submission via EDS to designated recipients 53. The information and optionally PDF documents are stored in and archive and a sortable database 54 within the data storage vault. 55.

Thus, specific embodiments of real-time employee verification have been disclosed. It should be apparent, however, to those skilled in the art that many more modifications besides those described are possible without departing from the inventive concepts herein. The inventive subject matter, therefore, is not to be restricted except in the spirit of the appended claims.

1. A real-time employee verification system comprising:
a potential employee;
an employer;
a live pre-registered Notary Public;
said potential employee having access to a data input device having an electronic digitizer to create and capture a digital signature;
said data input device further having a digital web-camera or video device capturing both streaming and live streaming video;
said input device is at a location that is remote from said live pre-registered Notary Public;
linking said employee with said live pre-registered Notary Public over a network or network server;
said network or network server secured communication link deploys an assessment screening survey requiring said potential employee to answer questions and or provide information regarding their said employer, identity, volition, duress, and awareness to execute the signing of an I-9 document;
if said assessment screening survey determines that said potential employee is not in compliance, said remote live pre-registered Notary Public can terminate said signing of an I-9 document;
if said assessment screening survey determines that said potential employee is in compliance said potential employee signs said I-9 document;
said identification is then compared to database(s) to determine employee eligibility verification, and
said employer is notified if said potential employee eligibility is verified or denied.

2. The real-time employee verification system according to claim 1 wherein said database(s) is at least one of social security, birth records, death records, driver's license, marriage records and previous verification(s).

3. The real-time employee verification system according to claim 1 that further includes providing a video digital certificate.

4. The real-time employee verification system according to claim 1 that further includes providing an embedded digital signature said signed I-9 document.

5. The real-time employee verification system according to claim 1 wherein said digital web-camera or video device connects via PBX routing said potential employee with a web cm to said pre-registered Notary Public.

6. The real-time employee verification system according to claim 1 that further includes accepting a method of payment from said potential employee or said employer.

7. The real-time employee verification system according to claim 1 that further includes a receipt printer for printing a receipt for monetary payment and a printer for printing a finalized electronic document.

8. The real-time employee verification system according to claim 1 wherein said system further includes at least one of a back-up server or an archival system.

9. The real-time employee verification system according to claim 1 wherein said potential employee eligibility is stored within an internet cloud where said potential employee eligibility is available at locations different from said potential employee said employer and said live pre-registered Notary Public.

10. The real-time employee verification system according to claim 1 that further includes a time and date stamping of said document.

11. A real-time employee verification system comprising:
a potential employee;
an employer;
a live employer agent;
said potential employee having access to a data input device having an electronic digitizer to create and capture a digital signature;
said data input device further having a digital web-camera or video device capturing both streaming and live streaming video;
said input device is at a location that is remote from said live employer agent;
linking said employee with said live employer agent over a network or network server;
said network or network server secured communication link deploys an assessment screening survey requiring said potential employee to answer questions and or provide information regarding their said employer, identity, volition, duress, and awareness to execute the signing of an I-9 document;
if said assessment screening survey determines that said potential employee is not in compliance, said remote live employer agent can terminate or deny said signing of an I-9 document;
if said assessment screening survey determines that said potential employee is in compliance said potential employee signs said I-9 document;
said identification is then compared to database(s) to determine employee eligibility verification, and
said employer is notified if said potential employee eligibility is verified or denied.

12. The real-time employee verification system according to claim 1 wherein said database(s) is at least one of social security, birth records, death records, driver's license, marriage records and previous verification(s).

13. The real-time employee verification system according to claim 1 that further includes providing a video digital certificate.

14. The real-time employee verification system according to claim 1 that further includes providing an embedded digital signature said signed I-9 document.

15. The real-time employee verification system according to claim 1 wherein said digital web-camera or video device connects via PBX routing said potential employee with a web cm to said employer agent.

16. The real-time employee verification system according to claim 1 that further includes accepting a method of payment from said potential employee or said employer.

17. The real-time employee verification system according to claim 1 that further includes a receipt printer for printing a receipt for monetary payment and a printer for printing a finalized electronic document.

18. The real-time employee verification system according to claim 1 wherein said system further includes at least one of a back-up server or an archival system.

19. The real-time employee verification system according to claim 1 wherein said potential employee eligibility is stored within an internet cloud where said potential employee eligibility is available at locations different from said potential employee said employer and said live employer agent.

20. The real-time employee verification system according to claim 1 that further includes a time and date stamping of said document.
